(19) United States
(12) Patent Application Publication
(10) Pub. No.: US 2011/0055110 A1
(43) Pub. Date: Mar. 3, 2011

(54) ONLINE CALCULATORS FOR OFFERING FINANCIAL PRODUCTS AND SERVICES

(76) Inventors: Vladimir Kolyvanov, Downingtown, PA (US); Avi Patel, Newark, DE (US); Ronald J. Kopcho, II, Pemberton, NJ (US)

(21) Appl. No.: 12/547,804

(22) Filed: Aug. 26, 2009

(51) Int. Cl. G06Q 40/00

(52) U.S. Cl. 705/36 R; 705/35; 705/38

(57) ABSTRACT

A system and method for receiving a user's financial information, calculating average corresponding financial information for a group of comparative individuals, displaying a customized virtual financial calculator, receiving data input by the user in the displayed customized virtual calculator, and offering a financial product or service calculated to be most appropriate to the user's needs based on the user and comparative data received.

### BACKGROUND OF THE INVENTION

Online financial calculators currently include a set of strict algorithms that are executed upon manual data input of the user. Such online calculators can be configured to receive various classes of data and to make various types of calculations. Some online calculators are configured to receive financial data such as loan amount, number of years, and interest rate, and to calculate payment amount. Others are configured to calculate savings rate at a selected interest rate assumption and number of years a user must save at that rate to achieve a financial goal.

Currently available online calculators do not work in interactive advisory mode and or consider any other information besides the data that was provided by the online user. Such calculators have a very limited role in educating an online user about the best options for the products and services.

It is an objective of the present invention of to improve on current online financial calculator data processing systems by taking into account a user's personal financial data, averaged data for other similar users, and current marketing conditions to present personalized advice and a rich selection of product and services in addition to conventional online calculator calculations.

### SUMMARY OF THE INVENTION

These objectives, and others which will become apparent from the following detailed description and drawings, are achieved by the present invention which comprises in one aspect a data processing system comprising a computer data storage medium and a computer processor programmed with a set of instructions configured to receive an individual user's personal financial data, to calculate and look up stored average financial data for a population of users who have characteristics in common with the user, and to look up stored data defining currently available financial products and services; to cause a virtual financial calculator to be displayed on a display; to receive the user's data input in the displayed virtual financial calculator; and to calculate the most appropriate financial product or service based on the personal financial data, data defining currently available financial products, the average financial data, data defining currently available financial products, and data inputted by the user in the selected virtual financial calculator.

In another aspect, the invention comprises a computer-based method of offering financial products and services over the internet to an individual user who has requested a virtual calculator over the internet comprising displaying a user-requested virtual calculator selected from the group consisting of a savings calculator, a mortgage calculator, a budget calculator, a credit card calculator, and an auto or home equity calculator; receiving a user's personal financial data, average financial data for a population of users which have characteristics in common with the user; and currently available financial products and services; automatically selecting an appropriate financial product or service; and displaying an offer of the selected financial product or service which is customized for the user.

### BRIEF DESCRIPTION OF THE DRAWINGS

FIG. 1 is a conventional prior art online calculator wherein an online user manually inputs data relating to existing loans, selects a type of consolidation loan, and an interest rate for the consolidation loan.

FIG. 2 is an online calculator of the invention.

FIG. 3 is a flow chart of a process according to the invention.

FIG. 4 is a flow chart of a process according to the invention.

FIG. 5 is a screen shot of a web page wherein a user researches available products on a retirement section of a website, wherein the computer system learns about user's behavior by processing the data entered by the user at the retirement section.

FIG. 6 is a screen shot of a web page wherein a user logs into the secure section of the site which requires login and authentication. The system authenticates user and get personal information, average financial data for a population of similar users who has characteristics in common with the user, and a list of available smart calculators to help user to refine and find the best offer.

FIG. 7 is a screen shot of a web page according to the invention wherein a retirement calculator is displayed.

FIG. 8 is a screen shot of a web page according to the invention wherein a retirement calculator is displayed and an estimate has been calculated.

FIG. 9 is a screen shot of a web page of an embodiment of an offer calculated by the computer system of the invention.

FIG. 10 is a screen shot of a web page which can be displayed in response to a selection at the web page illustrated in FIG. 9.

### DETAILED DESCRIPTION

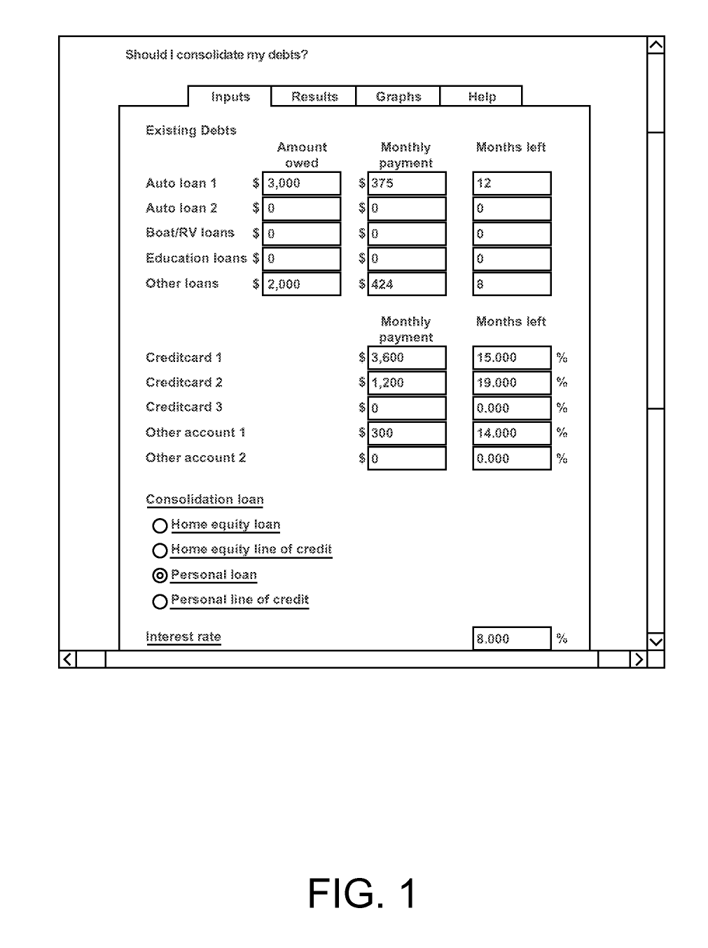

FIG. 1, illustrates a conventional prior art online calculator relating to consolidation loans. At a sponsor's web site, a user selects an online calculator which is programmed to receive financial data from the user, for example the amount owed on each outstanding loan and credit card, monthly payment, and current interest rate. The online user manually inputs data relating to existing loans, selects a type of consolidation loan, and an interest rate for the type of consolidation loan is populated by the system so that the user can determine if a single new loan would be more advantageous than the existing loans.

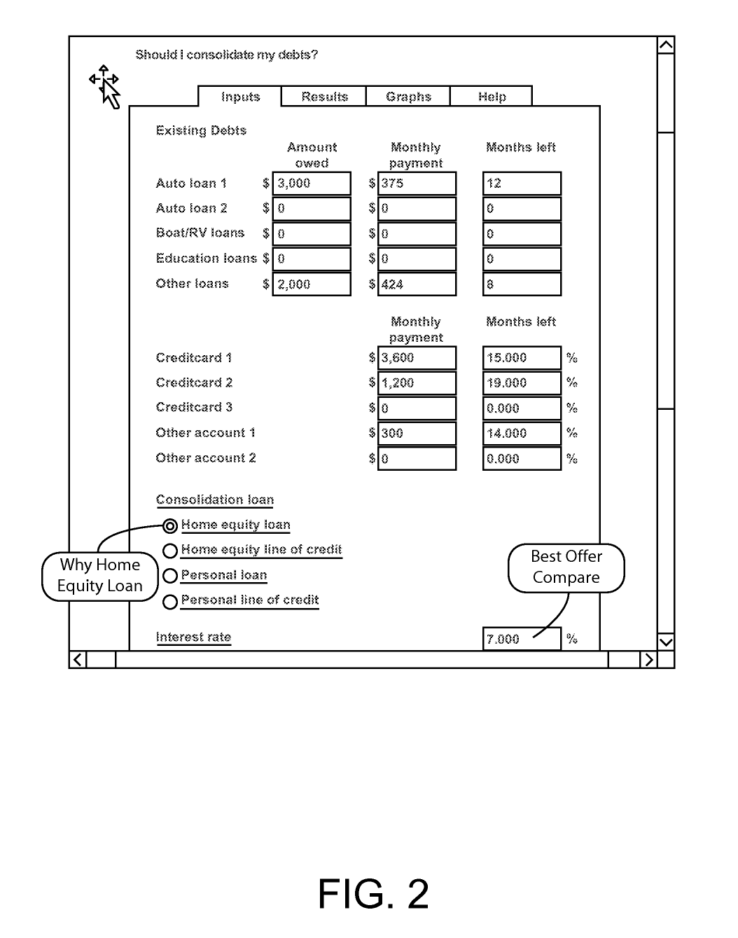

FIG. 2 is an illustration of an embodiment of the invention which is an improved online consolidation loan calculator which differs from the calculator of FIG. 1 in that it allows comparison with a loan offering of the sponsor of the web site. With the smart online calculator of the invention, interest rate will be pre-populated based on this user credit score and best available offer for this specific customer in comparison to the inferior offers from the competitors.

The best option for a consolidation loan would be highlighted and put on the top with an explanation of why it would be more beneficial comparing to other options. The system processes data on the particular user's credit history, attractiveness as a client, availability of the products/services, current promotions and current market conditions.

Although the online customer has an option to select consolidation loan and interest rate manually, the smart calculator system of the invention becomes a marketing tool to offer a customized product. Moreover any customer decision would be saved and used for the future decisions for this and other customers. The computer system of the invention includes a learning system module which processes and stores data from each transaction in order to predict future user behavior and improve prediction accuracy regarding optimum products and services for other users.

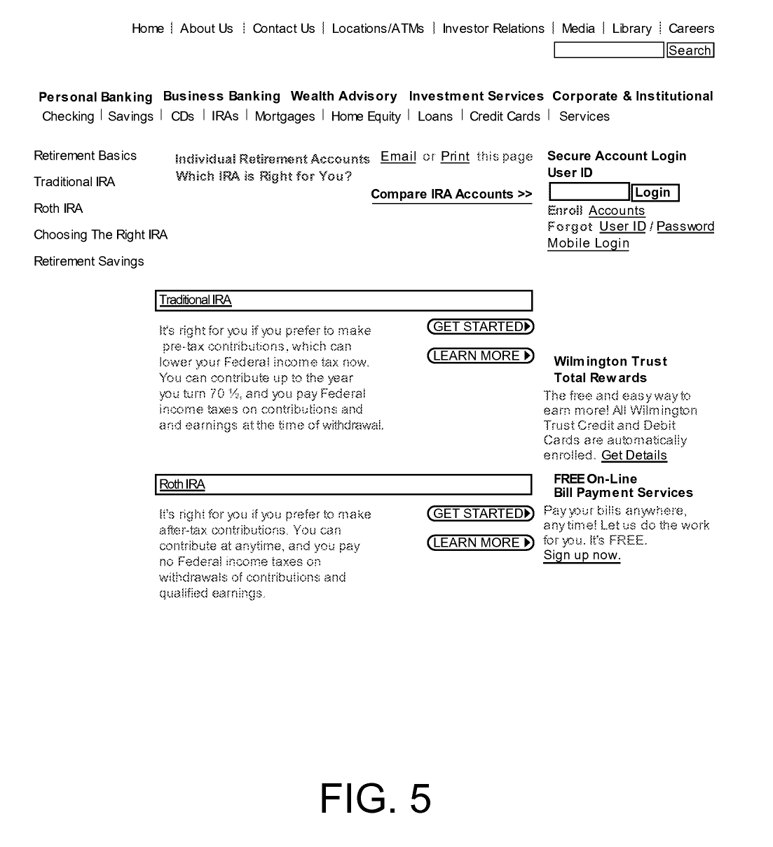

Referring now to FIG. 5, an embodiment of a screen shot of a web page wherein a user researches available products on a retirement section of a website is illustrated. In this embodiment, the computer system learns about user's behavior by processing the data entered by the user at the retirement section.

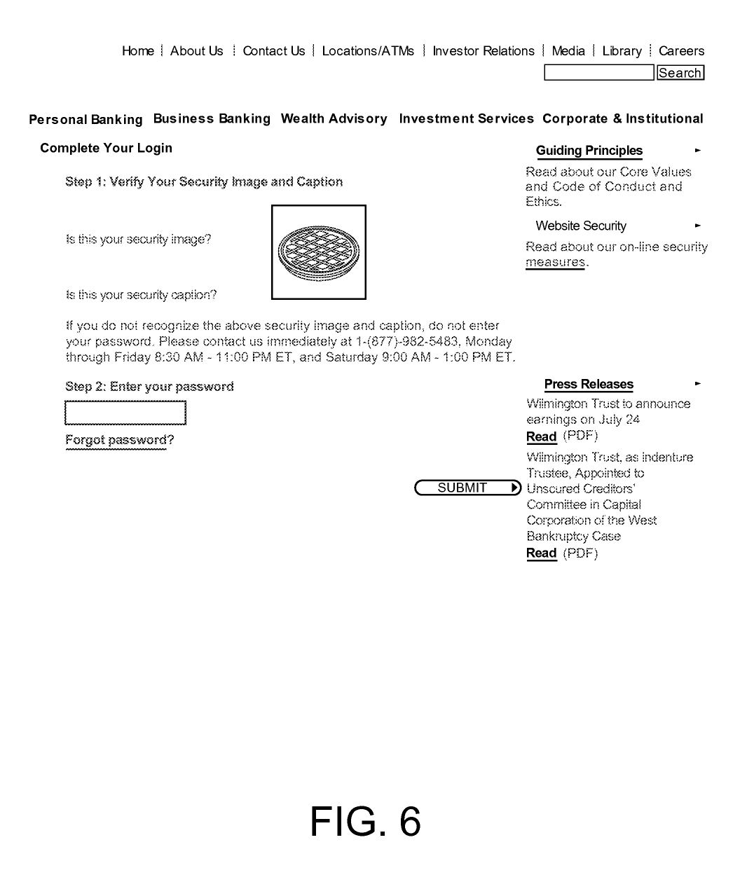

In FIG. 6, there is illustrated a screen shot of a web page wherein a user logs into the secure section of the site which requires login and authentication. The system authenticates the user and get personal information, average financial data for a population of similar users who has characteristics in common with the user, and a list of available smart calculators to help user to refine and find the best offer.

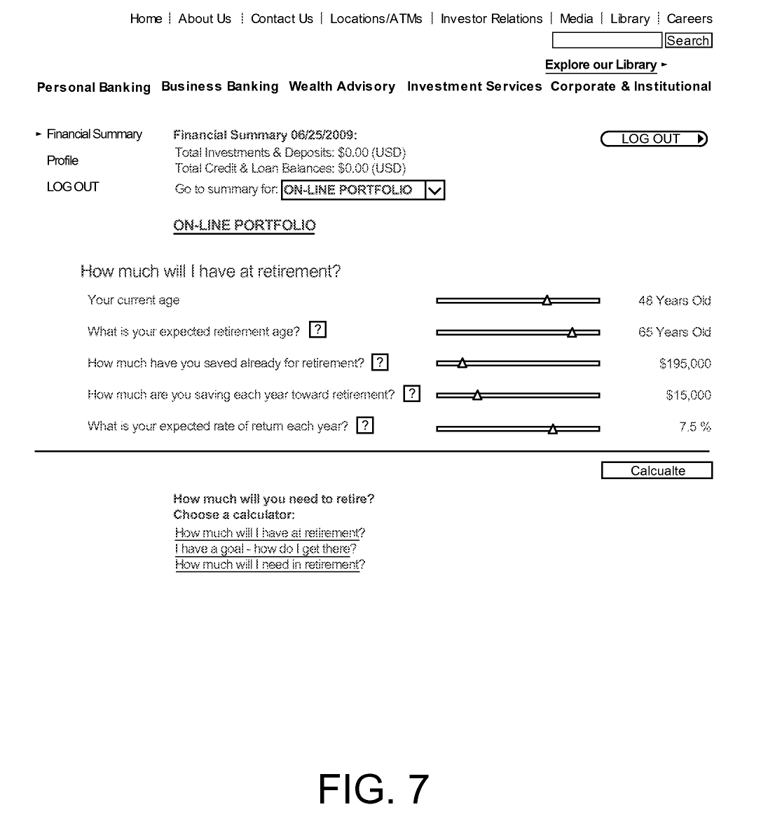

FIG. 7 is a screen shot of a web page wherein upon user login the computer system processes user input, selects the best fit from the list of smart calculators, and pre-populates the selected calculator with the user's personal data and potential recommendations based on average financial data for similar types of users. The user does has an option to select a smart calculator other than the suggested one.

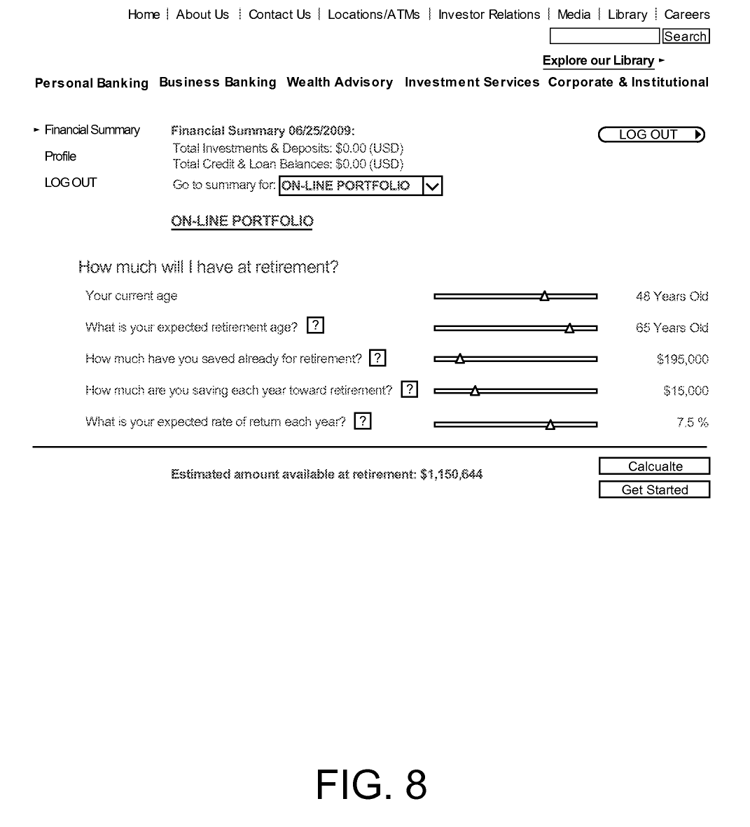

FIG. 8 is a screen shot of a web page wherein a user adjusts input parameters if necessary and has clicked “Calculate” button and calculated an estimated amount available at retirement. The computer system has calculates the data received from the user, analyzed the user's personal data, average financial for similar users, user's input, checks all available offers and selects the best one that suits user's needs.

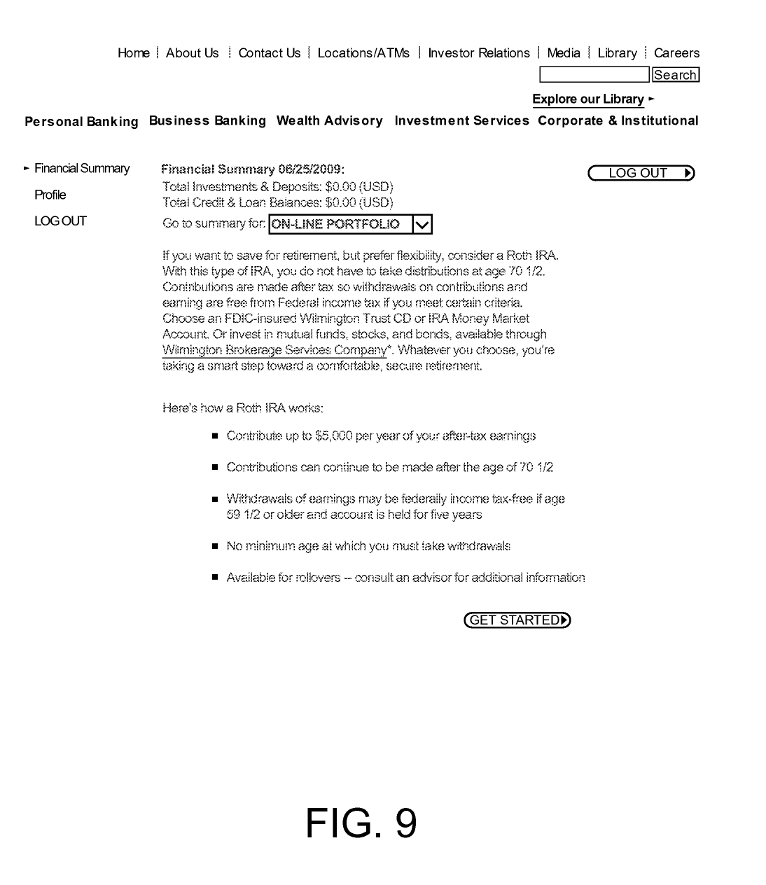

FIG. 9 is a screen shot of a web page wherein the system has calculated the most appropriate financial offer and displays it to the user. If user wishes to consider the offer, the user clicks on “get started” button. The system learns about user's behavior from the user's data input and selection history. If user does not like the offer, the user has an option to decline it.

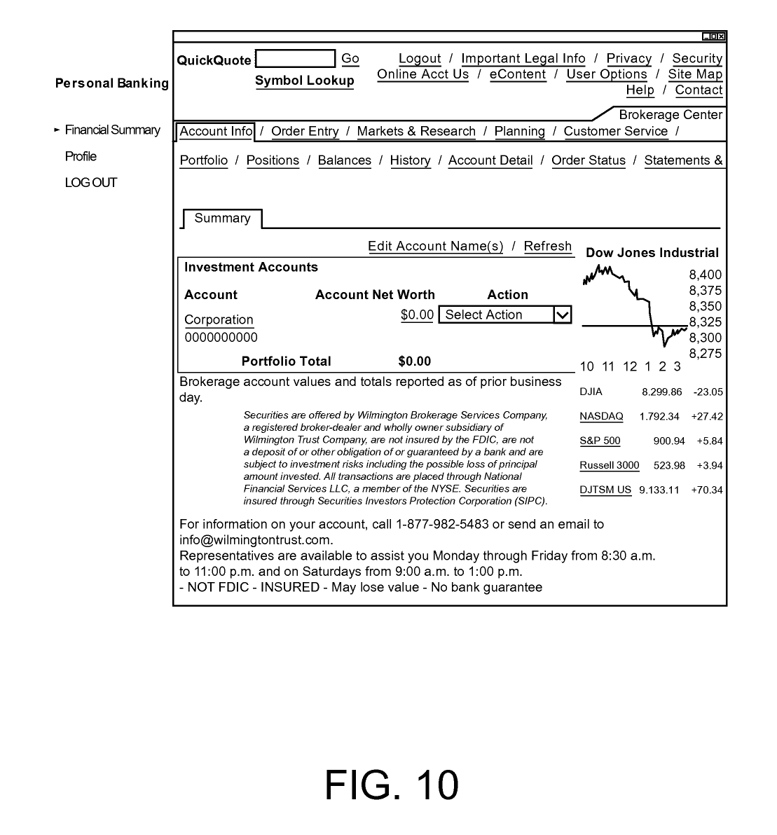

FIG. 10 is a screen shot of a web page wherein if the user accepts the offer illustrated in FIG. 9, the system displays a brokerage transaction screen so the user can complete a transaction. The system records the transaction and learns user's behavior.

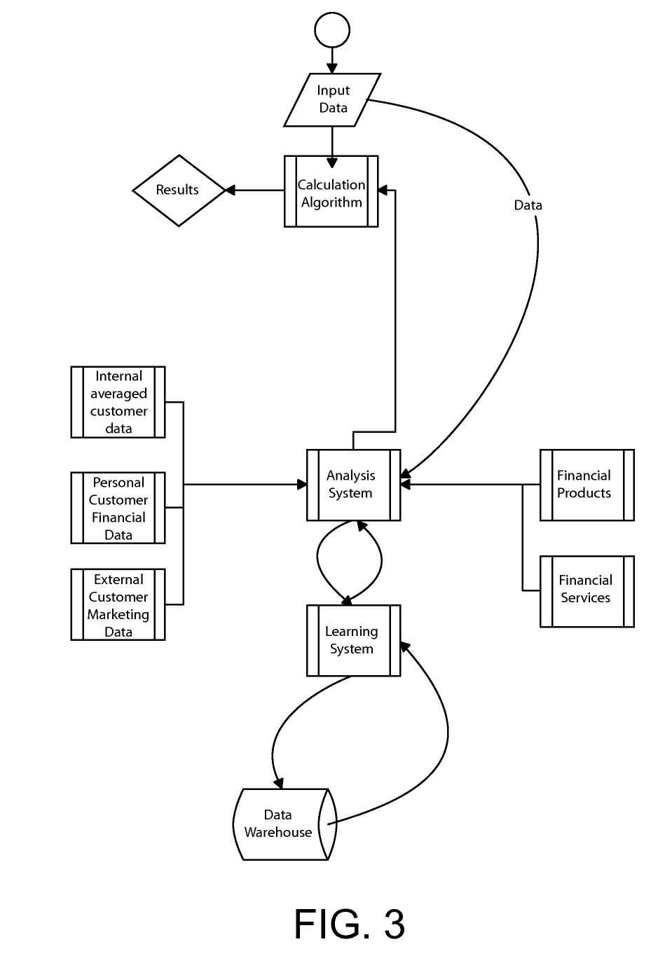

Referring now to FIG. 3, a flow chart of an embodiment of a process of the invention is illustrated, the general process carried out by the programmed computer system of the invention, the system starts 100 with data being input 101 and processed 103 according to an algorithm with results 112. Data 102 is sent from the user input 101 to the analysis module 104 which processes data from internal averaged customer data 107, personal customer data 108 relating to the individual user who has logged in and whose financial data is stored, and existing customer marketing data 109 which includes data from a plurality of marketing events with a plurality of customers. All of the data is stored 111 in one or more computer databases. The system has a learning module 110 which exchanges data with the analysis system and data storage. Financial products module 105 and financial services module 106 are configured to provide the most appropriate offerings to the user based on the integrated averaged customer data 107, personal consumer financial data 108, and existing customer marketing data 109.

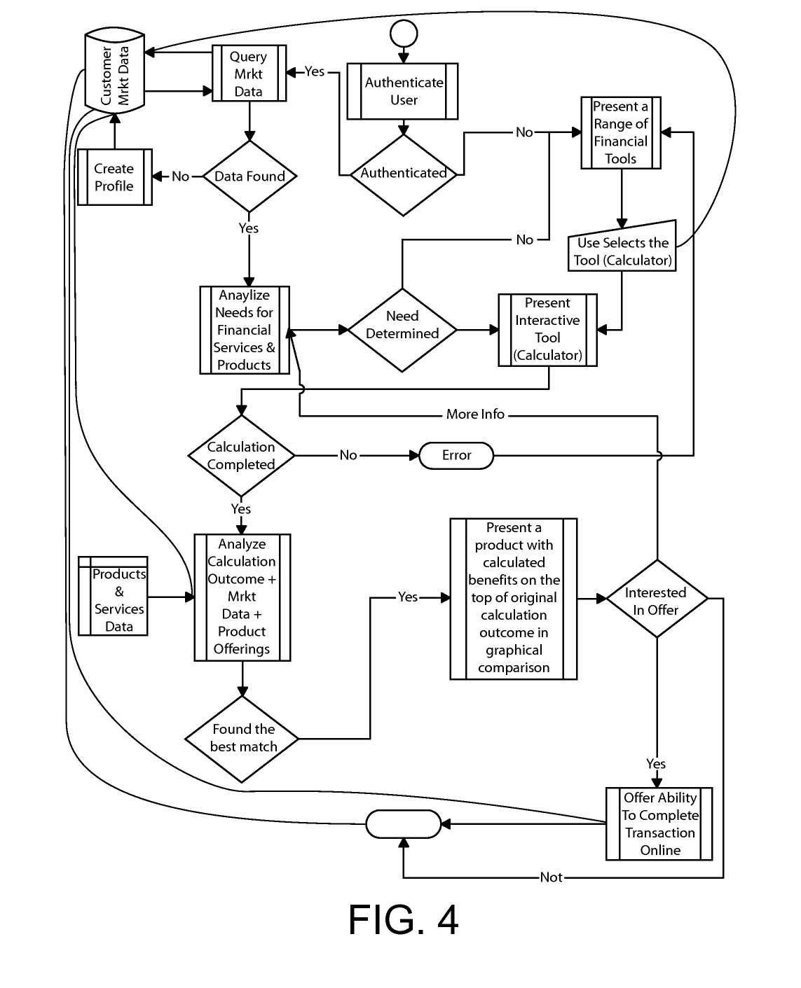

FIG. 4 is a flow chart which starts 200 with authentication 201 of the user and upon authentication 202, marketing data is queried 204, using stored marketing data 219, to create a profile 218 if existing data is not found 205, otherwise an analysis module 217 is used to determine if a need exists 216. If such need exists, an interactive calculator tool 207 is presented or displayed, otherwise a range of financial tools is presented 203, and the user selects a tool, e.g. a calculator 206. If the calculation is complete 208, a module 210 analyzes the calculation outcome, marketing data, and product offerings, looks up available products and services data 215, and determines the best match 212. If the calculation 208 is not completed due to an error 209, the range 203 of financial tools is presented or continued to be displayed.

An especially novel feature of the invention is exemplified at decision block 212 where the best match may be found in which case the user is presented 211 with a product with calculated benefits on the top of the original calculation outcome in graphical comparison. If the user is interested in the offer 213, the transaction can be completed 214 by the completion module, otherwise the process ends 220.

The present invention, therefore, is well adapted to carry out the objects and attain the ends and advantages mentioned, as well as others inherent therein. While the invention has been depicted and described and is defined by reference to particular preferred embodiments of the invention, such references do not imply a limitation on the invention, and no such limitation is to be inferred. The invention is capable of considerable modification, alteration and equivalents in form and function, as will occur to those ordinarily skilled in the pertinent arts. The depicted and described preferred embodiments of the invention are exemplary only and are not exhaustive of the scope of the invention. Consequently, the invention is intended to be limited only by the spirit and scope of the appended claims, giving full cognizance to equivalents in all respects.

What is claimed is:

1. A data processing system comprising a computer data storage medium and a computer processor programmed with a set of instructions configured to receive a user's personal financial data, to calculate and look up stored average financial data for a population of users who have characteristics in common with the user, and to look up stored data defining currently available financial products and services; to cause a virtual financial calculator to be displayed on a display; to receive the user's data input in the displayed virtual financial calculator; and to calculate the most appropriate financial product or service based on the personal financial data, average financial data, and data inputted by the user in the selected virtual financial calculator.

2. The data processing system of claim 1 wherein the financial calculator is selected from the group consisting of a savings calculator, a mortgage calculator, a budget calculator, a credit card calculator, a retirement calculator, a mutual fund calculator, an auto calculator, and an home equity calculator.

3. The data processing system of claim 1 wherein the financial products or services are selected from an auto loan at a calculated term and interest rate, a home mortgage at a calculated term and interest rate, a second mortgage at a calculated term and interest rate, a savings account at a calculated interest rate, and a checking account.

4. The data processing system of claim 1 wherein the financial products or services are selected from an auto loan at a calculated term and interest rate, a home mortgage at a calculated term and interest rate, a second mortgage at a calculated term and interest rate, a savings account at a calculated interest rate, and a checking account, and wherein the interest rate and term are compared to competitive offerings of the financial products or services.

5. A computer based method of offering financial products and services comprising displaying a virtual financial calculator; receiving a user's personal financial data, average financial data for a population of users which have characteristics in common with the user; and currently available financial products and services; automatically selecting an appropriate financial product or service; and displaying an offer of the selected financial product or service which is customized for the user.

6. The method of claim 5 wherein the financial calculator is selected from the group consisting of a savings calculator, a mortgage calculator, a budget calculator, a credit card calculator, a retirement calculator, a mutual fund calculator, an auto calculator, and an home equity calculator.
